(19) United States
(12) Patent Application Publication
(10) Pub. No.: US 2026/0197669 A1
(43) Pub. Date: Jul. 9, 2026

(54) REPEATER NODE FOR DUAL-POLARIZED BEAMFORMING

(71) Applicant: Telefonaktiebolaget LM Ericsson (publ), Stockholm (SE)

(72) Inventors: Sven PETERSSON, Sävedalen (SE); Andreas NILSSON, Göteborg (SE); Fredrik ATHLEY, Västra Frölunda (SE)

(73) Assignee: Telefonaktiebolaget LM Ericsson (publ), Stockholm (SE)

(21) Appl. No.: 18/868,210

(22) PCT Filed: May 25, 2022
(86) PCT No.: PCT/EP2022/064350

§ 371 Date: Nov. 22, 2024

(51) Int. Cl. H04W 16/28; H04B 7/10; H04W 16/26

(52) U.S. Cl. CPC H04W 16/28; H04B 7/10; H04W 16/26

(57) ABSTRACT

There is provided a repeater node for dual-polarized beamforming towards user equipment. The repeater node comprises a first antenna array for communication with a transmission and reception point of a network node, and a second antenna array for communication with the user equipment. The first antenna array comprises antenna elements of a first polarization and antenna elements of a second polarization. The second antenna array comprises antenna elements of a third polarization and antenna elements of a fourth polarization. The antenna elements of the first antenna array are connectible to the antenna elements of the second antenna array via circuitry. The antenna elements of each of the first polarization and the second polarization in the first antenna array are, via the circuitry, connectable to antenna elements of both the third polarization and the fourth polarization in the second antenna array.

### TECHNICAL FIELD

Embodiments presented herein relate a repeater node for dual-polarized beamforming towards user equipment, as well as a method, a controller module, a computer program, and a computer program product for using the repeater node.

### BACKGROUND

Millimeter waves (mmWaves) corresponding to carrier frequencies above 10 GHz have been introduced for the new radio (NR) air interface as used in fifth generation (5G) telecommunication systems. However, communication over mmWaves is sensible to blocking, i.e., physical objects blocking the radio waves.

Therefore, to increase data rates and support an increasing number of user equipment to be served, different techniques have been considered. One technique involves network densification. In general terms, network densification refers to the deployment of multiple access points of different types in, e.g., metropolitan areas. Particularly, it is expected that small access points, such as relays, integrated access and backhaul (IAB) nodes, repeaters, intelligent reflecting surfaces (IRSs), etc., will be densely deployed to assist existing macro access points.

IAB nodes have been considered as representing main technique in 5G telecommunication systems for providing relaying between a macro access point and one or more user equipment. IAB nodes might be stationary or movable (defining so-called mobile IAB nodes). IAB nodes commonly implement decode-and-forward relaying techniques. This causes IAB nodes to have advanced receiver and transmitter chains, to have comparatively high energy consumption, and require a comparatively complicated electro-mechanical construction. This has motivated the use of alternative techniques, such as repeaters.

However, although repeaters might require less energy consumption and have a simpler electro-mechanical construction than IAB nodes, they also have drawbacks. One such drawback comes from the lack of advanced receiver and transmitter chains. This impacts the functionality, and thus use, of repeaters in some scenarios. One example of scenarios where traditional repeaters are unsuitable, or even unusable, is where dual-polarized beamforming is used for the communication between access points and user equipment.

### SUMMARY

An object of embodiments herein is to address the above issues by providing repeater nodes capable of dual-polarized beamforming.

According to a first aspect there is presented a repeater node for dual-polarized beamforming towards user equipment. The repeater node comprises a first antenna array for communication with a transmission and reception point of a network node, and a second antenna array for communication with the user equipment. The first antenna array comprises antenna elements of a first polarization and antenna elements of a second polarization. The second antenna array comprises antenna elements of a third polarization and antenna elements of a fourth polarization. The antenna elements of the first antenna array are connectible to the antenna elements of the second antenna array via circuitry. The antenna elements of each of the first polarization and the second polarization in the first antenna array are, via the circuitry, connectable to antenna elements of both the third polarization and the fourth polarization in the second antenna array.

According to a second aspect there is presented a method for using a repeater node according to the first aspect for dual-polarized beamforming towards user equipment. The method comprises receiving a signal in the first antenna array from the transmission and reception point. The method comprises forwarding the signal from the first antenna array to the second antenna array via the circuitry. The method comprises transmitting the signal from the second antenna array towards the user equipment.

According to a third aspect there is presented a controller module for using a repeater node according to the first aspect for dual-polarized beamforming towards user equipment. The controller module comprises processing circuitry. The processing circuitry is configured to cause the controller module to perform a method according to the second aspect.

According to a fourth aspect there is presented a computer program for i using a repeater node according to the first aspect for dual-polarized beamforming towards user equipment. The computer program comprises computer program code which, when run on a controller module, causes the controller module to perform a method according to the third aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously these aspects enable the repeater node to perform efficient dual-polarized beamforming towards user equipment.

In turn, this enables the repeater node to generate flexible beamwidths and beam shapes without reducing its power efficiency.

In turn, this enables the repeater node to be used in installations or deployments where such flexible beamwidths and beam shapes are needed.

Such flexible beamwidths and beam shapes might be needed during transmission of certain types of reference signals, such as synchronization signal block (SSB) signals, broadcast signals, multi-cast signals, etc.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communications network according to an example;

FIG. 2 is a block diagram of a repeater node according to an example;

FIGS. 3-10 are block diagrams of antenna systems of a repeater node according to embodiments;

FIG. 11 is a flowchart of methods according to embodiments;

FIG. 12 is a schematic diagram showing functional units of a controller module according to an embodiment;

FIG. 13 is a schematic diagram showing functional modules of a controller module according to an embodiment; and

FIG. 14 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

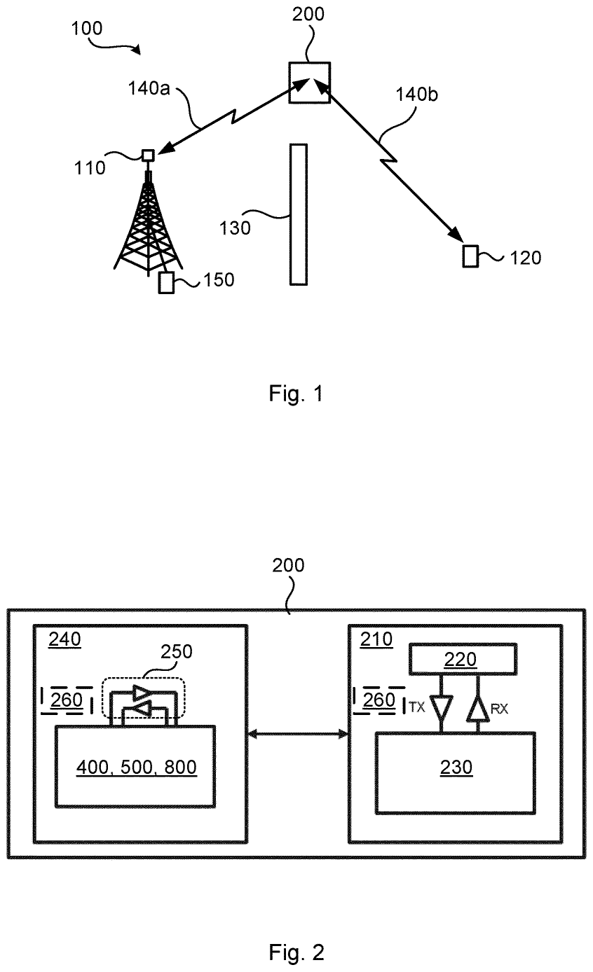

FIG. 1 is a schematic diagram illustrating a communication network 100 where embodiments presented herein can be applied. The communication network 100 comprises a network node 150 having a transmission and reception point 110. The network node 150, via its transmission and reception point 110, is to serve user equipment 120. However, as schematically illustrated in FIG. 1, an obstacle 130, such as a physical structure, obstructs the line-of-sight path between the transmission and reception point 110 and the user equipment 120. The transmission and reception point 110 and the user equipment 120 therefore communicates via a repeater node 200 over wireless links 140a, 140b.

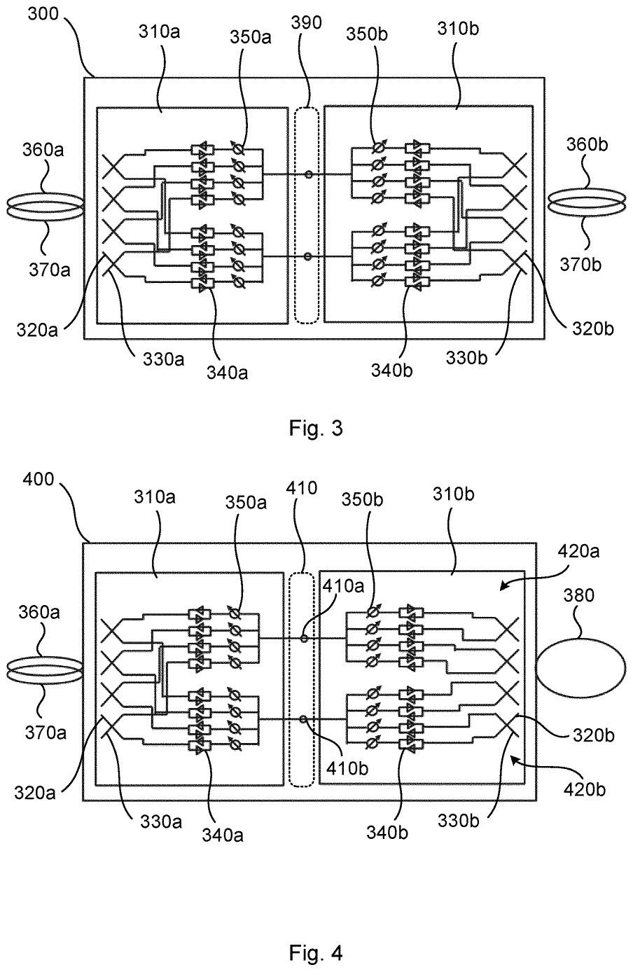

Details of the repeater node 200 will be disclosed next with reference to the block diagram of FIG. 2. The repeater node 200 comprises a controller module 210 and a repeater module 240.

The repeater module 240 is equipped with an antenna system 400, 500, 800, where a signal is first received, and after power amplification (accomplished by means of a signal amplifier arrangement 250 comprising power amplifiers), transmitted again. Since the repeater module 240 only amplifies and beamforms (using analog beamforming) the signal, no advanced receiver or transmitter chains are required. This reduces the cost, energy consumption, and electro-mechanical construction, compared to, for example, a traditional transmission and reception point 110.

The controller module 210 is configured to control the repeater module 240, by, for example, providing beamforming information, power control information, etc. to be applied at the repeater module 240 and in particular at the antenna system 400, 500, 800 and the signal amplifier arrangement 250. The controller module 210 is operatively connected to the network such that the network can control the controller module 210 and, in that way, control the repeater module 240. The controller module 210 is equipped with a communication interface 230, a transmit (TX) chain, a receive (RX) chain and baseband circuitry 220 for receiving control signaling from the network and for providing the network with information about the repeater node 230. The communication interface 230 might be configured for either wired or wireless communication with the network. In this respect, although depicted as a separate entity, the controller module 210 might utilize the antenna system 400, 500, 800, or a subset thereof, for its communication with the network. In any case, the communication interface 230 implements a fast connection between the repeater node 200 and the network.

An optional measurement module 260 might be placed in either the repeater module 240 or the controller module 210. Further details of the measurement module 260 will be disclosed below.

The repeater module 240 and the controller module 210 could, at the same time, be communicating with two respectively different transmission and reception points 110 or one and the same transmission and reception point 110. In case two different transmission and reception points 110 are used, the two transmission and reception points 110 can be located at the same location, or at separated locations, and the two transmission and reception points 110 can either communicate over the same frequency band or over different frequency bands.

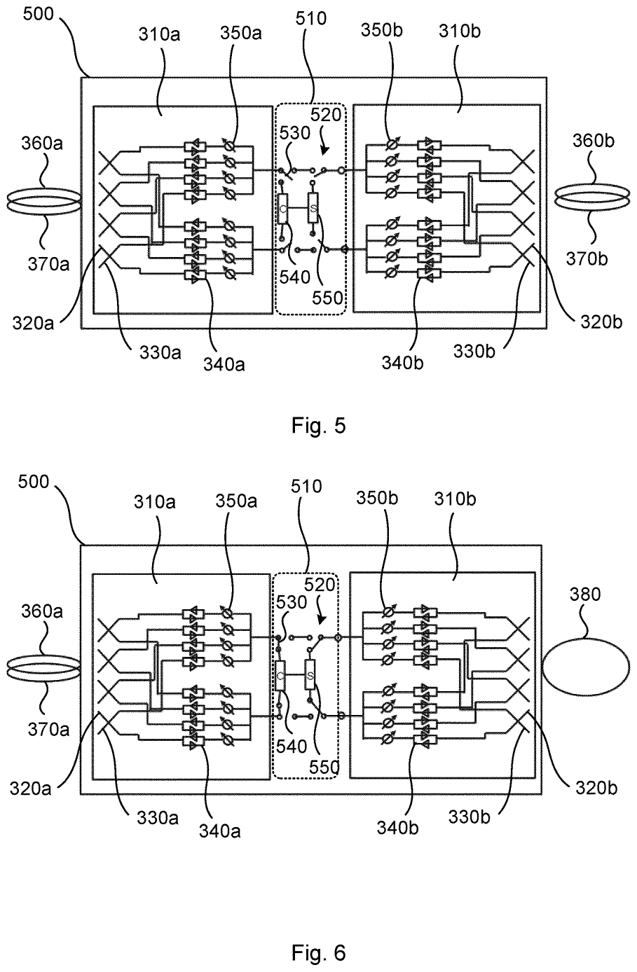

Before disclosing properties of the herein proposed antenna systems 400, 500, 800, reference will, for comparison, first be made to the antenna system 300 of FIG. 3. In some aspects, the antenna system 300 represents a traditional antenna system for a repeater node. However, as will be disclosed below, the antenna system is not capable of dual-polarized beamforming towards the user equipment 120.

The antenna system 300 comprises a first antenna array 310a for communication with the transmission and reception point 110 and a second antenna array 310b for communication with the user equipment 120.

The first antenna array 310a comprises antenna elements, one of which is identified at reference numeral 320a, of a first polarization and antenna elements, one of which is identified at reference numeral 330a, of a second polarization. The second antenna array 310b comprises antenna elements, one of which is identified at reference numeral 320b, of a third polarization and antenna elements, one of which is identified at reference numeral 330b, of a fourth polarization.

The antenna system 300 is equipped with one power amplifier and low noise amplifier, per each of the antenna elements 320a, 330a, 320b, 330b, as indicated at reference numerals 340a, 340b. The power amplifier and low noise amplifier are used to amplify and forward received signals. The antenna system 300 is further equipped with one phase shifter per each of the antenna elements 320a, 330a, 320b, 330b, as indicated at reference numerals 350a, 350b. The phase shifters are used generate directional beams 360a, 370a, 360b, 370b, 380.

The antenna elements 320a, 330a of the first antenna array 310a are connected to the antenna elements 320b, 330b of the second antenna array 310b via circuitry 390. According to the antenna system 300, the antenna elements 320a of the first polarization in the first antenna array 310a are connected exclusively to the antenna elements 320b of the third polarization in the second antenna array 310b. Likewise, the antenna elements 320b of the second polarization in the first antenna array 310a are connected exclusively to the antenna elements 330b of the fourth polarization in the second antenna array 310b.

Accordingly, a signal received in a beam 360a of the first polarization at the first antenna array 310a is propagated through the circuitry 390 and transmitted in a beam 360b of the third polarization at the second antenna array 310b. Likewise, a signal received in a beam 370a of the second polarization at the first antenna array 310a is propagated through the circuitry 390 and transmitted in a beam 370b of the fourth polarization at the second antenna array 310b. In this way, reception in the first polarization is mapped to transmission in the third polarization, and reception in the second polarization is mapped to transmission in the fourth polarization. This results in single-polarized beamforming towards the user equipment 140.

Depending on the installation and the deployment of the repeater node 200, the repeater node 200 needs to be configured to generate a variety of beam widths. In this respect, finding precoders that form wide beams from large antenna arrays 310a, 310b using only phase shifters 350a, 350b is challenging and typically results in significant beam ripple in case conventional single-polarized beamforming, as in FIG. 3, is used. The beam ripple can be mitigated, or reduced, if instead dual-polarization beamforming is applied. In general terms, dual-polarization beamforming is a technique where a resulting beam is given by the total power, i.e., the sum of powers from two orthogonal polarizations. With this technique polarization as such is not seen as an important parameter. What is important is the fact that precoders can be designed that form beams with identical total power pattern and with orthogonal polarization in any direction.

Dual-polarized beamforming is expected to be used to a large extent at mmWave (and sub-Tera Hz) beamforming to generate wide, or semi-wide, beams for antenna arrays with a high number of antenna elements, whilst still maintaining a high output power amplifier efficiency. Wide, or semi-wide, beams are for example used at the transmission and reception point 110 when transmitting certain types of reference signals, such as SSB signals, broadcast signals, multi-cast signals, etc. It is expected that similar features will be useful also for repeater nodes 200. Since the repeater node 200 at least from the perspective of the user equipment 120 can be regarded as mimicking the behavior the transmission and reception point 110, the repeater node 200 should be enabled to generate wide beams, at least at the antenna array used for communication with the user equipment 120 when forwarding signals transmitted in wide, or semi-wide, beams at the transmission and reception point 110.

To properly enable dual-polarized beamforming, the amplitude of the transmitted signal in each respective polarization needs to be approximately the same. However, for a repeater node 200, the received signals in each polarization will depend partly on how the signal is transmitted from the transmission and reception point 110 and partly on the propagation channel between the transmission and reception point 110 and the repeater node 200. Neither of these factors are typically controllable by the repeater node 200. This means that the amplitude of the received signal in the first polarization and the second polarization might will be more or less random, for example due to polarization mismatch. This means that if either single-polarization or even if dual-polarization beamforming is applied at the transmission and reception point 110, the repeater node 200 with an antenna system 300 as in FIG. 3 will not be able to apply proper dual-polarized beamforming for the transmission towards the user equipment 120.

Aspects, embodiments, and examples of antenna systems 400, 500, 800 for dual-polarized beamforming towards the user equipment 120 will now be disclosed with reference to the block diagrams of antenna systems 400, 500, 800 as illustrated in FIGS. 4 to 10. The following is thus common for all the antenna systems 400, 500, 800 illustrated in FIGS. 4 to 10.

All these antenna systems 400, 500, 800 commonly comprise a first antenna array 310a for communication with the transmission and reception point 110. All these antenna systems 400, 500, 800 further commonly comprise a second antenna array 310b for communication with the user equipment 120.

The first antenna array 310a comprises antenna elements 320a of a first polarization and antenna elements 330a of a second polarization. The second antenna array 310b comprises antenna elements 320b of a third polarization and antenna elements 330b of a fourth polarization. In some examples the first polarization is orthogonal to the second polarization, and the third polarization is orthogonal to the fourth polarization.

The antenna elements 320a, 330a of the first antenna array 310a are connectible to the antenna elements 320b, 330b of the second antenna array 310b via circuitry 410, 510, 810. Different embodiments regarding how the antenna elements 320a, 330a of the first antenna array 310a are connectible to the antenna elements 320b, 330b of the second antenna array 310b will be disclosed below. Different embodiments regarding how the circuitry 410, 510, 810 can be implemented will also be disclosed below.

The antenna elements 320a, 330a of each of the first polarization and the second polarization in the first antenna array 310a are, via the circuitry 410, 510, 810, connectable to antenna elements 320b, 330b of both the third polarization and the fourth polarization in the second antenna array 310b.

Accordingly, a signal received in a beam 360a of the first polarization at the first antenna array 310a is propagated through the circuitry 390 and transmitted in the third polarization as well as in the fourth polarization at the second antenna array 310b. Hence, the signal is transmitted in a beam 380 created by dual-polarized beamforming (where the beam 380 has a single polarization that is different in different angle). Likewise, a signal received in a beam 370a of the second polarization at the first antenna array 310a is propagated through the circuitry 410, 510, 810 and transmitted in the third polarization as well as in the fourth polarization at the second antenna array 310b. Hence, also this signal is transmitted in the beam 380. In this way, reception in the first polarization as well as in the second polarization is mapped to transmission in both the third polarization and the fourth polarization. This results in dual-polarized beamforming towards the user equipment 140.

A first embodiment of the proposed antenna system will now be disclosed with reference to FIG. 4.

FIG. 4 illustrates an example where dual-polarized beamforming is performed over two different subarrays, or sub-panels. In more detail, in FIG. 4 is illustrated an antenna system 400 where the second antenna array 310b is split into a first subarray 420a and a second subarray 420b. The dual-polarized beamforming towards the user equipment 120 is then performed per each of the subarrays 420a, 420b.

In this embodiment, the circuitry 410 comprises wires 410a, 410b connecting the first antenna array 310a to the second antenna array 310b. The wires 410a, 410b connect the antenna elements 320a, 330a in the first antenna array 310a to the first subarray 420a and the second subarray 420b in the second antenna array 310b. In more detail, the circuitry 410 comprises a first wire 410a connecting all the antenna elements 320a of the first polarization in the first antenna array 310a to a first half of all the antenna elements 320b of the third polarization in the second antenna array 310b and to a first half of all the antenna elements 330b of the fourth polarization in the second antenna array 310b. The circuitry 410 further comprises a second wire 410b connecting all the antenna elements 330a of the second polarization in the first antenna array 310a to a second half of all the antenna elements 320b of the third polarization in the second antenna array 310b and to a second half of all the antenna elements 330b of the fourth polarization in the second antenna array 310b. This is not the case for the circuitry 390 in FIG. 3. The first half of all the antenna elements 320b of the third polarization in the second antenna array 310b and the first half of all the antenna elements 330b of the fourth polarization in the second antenna array 310b define the first subarray 420a. The second half of all the antenna elements 320b of the third polarization in the second antenna array 310b and the second half of all the antenna elements 330b of the fourth polarization in the second antenna array 310b define the second subarray 420b.

Hence, the antenna system 400 illustrates a schematic example where, in comparison to the antenna system 300, the connections between the antenna elements 320a, 330a in the first antenna array 310a and the antenna elements 320b, 330b in the second antenna array 310b are different. As disclosed above, and as is apparent from FIG. 4, for the first antenna array 310a used for communication with the transmission and reception point 110, the antenna elements 320a, 330a associated with each polarization are connected to antenna elements 320b, 330b of both polarizations in the second antenna array 310b used to communicate with the user equipment 120. In this way, dual-polarized beamforming can be performed over two different subarrays 420a, 420b, each composed of antenna elements of both the third polarization and the fourth polarization. Since, the relative phase and amplitude is known for the different antenna elements 320b, 330b for each respective subarray 420a, 420b, proper dual-polarized beamforming can be performed at the second antenna array 310b used for communication with the user equipment 120.

A second embodiment and a third embodiment of the proposed antenna system will now be disclosed with reference to FIGS. 5 to 10, where an antenna system 500 according to the second embodiment is illustrated in FIGS. 5 to 7, and an antenna system 800 according to the third embodiment is illustrated in FIGS. 8 to 10. However, before disclosing the details of each of these embodiments, details that are common for both these embodiments will be disclosed.

The second embodiment and the third embodiment have in common that the circuitry 510, 810 comprises a switching network 520, 820 to selectively switch the repeater node 200 between operating in a dual-polarizing beamforming state and operating in a unicast state. By means of the switching network 520, 820, the second antenna array 310b can be kept unaltered compared to the antenna system 300.

Details of the switching network 520, 820 will be disclosed below.

As illustrated in FIG. 5 for the antenna system 500 of the second embodiment and in FIG. 8 for the antenna system 800 of the third embodiment, the switching network 520, 820 also has a neutral state. In the neutral state the first antenna array 310a and the second antenna array 310b are disconnected from each other. Although not used in practice, respective illustrations of the neutral state for the antenna systems 500, 800 are provided mainly to indicate the placement of the individual switches 530, 830 of the switching network 520, 820.

In the unicast state the switching network 520, 820 is set to connect the antenna elements 320a of the first polarization in the first antenna array 310a to antenna elements 320b of the third polarization in the second antenna array 310b. In the unicast state the switching network 520, 820 is further set to connect the antenna elements 330a of the second polarization in the first antenna array 310a to antenna elements 330b of the fourth polarization in the second antenna array 310b. FIG. 7 shows an example of an antenna system 500 according to the second embodiment where the switching network 520 is set for the repeater node 200 to operate in the unicast state. FIG. 9 shows an example of an antenna system 800 according to the third embodiment where the switching network 820 is set for the repeater node 200 to operate in the unicast state. In the unicast state, the antenna systems 500, 800 operate as the antenna system 300 of FIG. 3. The unicast state can be used, for example, when unicast multi-layer transmission is to be applied with narrow beams 360b, 370b are to be used for transmission towards the user equipment 120.

In the dual-polarizing beamforming state the switching network 520, 820 is set to connect the antenna elements 320a, 330a of each of the first polarization and the second polarization in the first antenna array 310a to antenna elements 320b, 330b of both the third polarization and the fourth polarization in the second antenna array 310b. FIG. 6 shows an example of an antenna system 500 according to the second embodiment where the switching network 520 is set for the repeater node 200 to operate in the dual-polarizing beamforming state. FIG. 10 shows an example of an antenna system 800 according to the third embodiment where the switching network 820 is set for the repeater node 200 to operate in the dual-polarizing beamforming state. In the dual-polarizing beamforming state, a signal received in a beam 360a of the first polarization at the first antenna array 310a is propagated through the circuitry 510, 810 and transmitted in the third polarization as well as in the fourth polarization at the second antenna array 310b. Hence, the signal is transmitted in a beam 380 created by dual-polarized beamforming. Likewise, a signal received in a beam 370a of the second polarization at the first antenna array 310a is propagated through the circuitry 510, 810 and transmitted in the third polarization as well as in the fourth polarization at the second antenna array 310b. Hence, also this signal is transmitted in the beam 380. In this way, reception in the first polarization as well as in the second polarization is mapped to transmission in both the third polarization and the fourth polarization. This results in dual-polarized beamforming towards the user equipment 140. The dual-polarizing beamforming state might, for example, be used during transmission of reference signals from the network node 150, during multi-cast transmission, and/or during broadcast transmission which typically corresponds to a single layer transmission and where semi-wide, or wide beams 380 are preferred, or even required.

Particular details of the second embodiment of the proposed antenna system will now be disclosed with continued reference to FIGS. 5, 6, and 7.

In accordance with the second embodiment, a signal received in the first polarization and the second polarization at the first antenna array 310a is first combined and then split in two equal parts, where each of the two parts is fed to separate polarizations at the second antenna array 310b. In particular, in the dual-polarizing beamforming state the switching network 520, 820 is set to at the same time connect all the antenna elements 320a, 330a in the first antenna array 310a to all the antenna elements 320b, 330b in the second antenna array 310b. In this way the amplitude will be the same for both the third polarization and the fourth polarization, which will enable proper dual-polarized beamforming.

According to the second embodiment, the switching network 520 comprises switches 530, at least one signal combiner 540, and at least one signal splitter 550. In FIGS. 5, 6, and 7, the switching network 520 comprises exactly four switches 530, exactly one signal combiner 540, and one exactly signal splitter 550. In some examples, the at least one signal combiner 540 is a maximum ratio combiner configured to combine signals received at the antenna elements 320a of the first polarization in the first antenna array 310a with signals received at the antenna elements 330a of the second polarization in the first antenna array 310a.

With a signal combiner 540 connected to the antenna elements 320a, 330a of both the first polarization and the second polarization in the first antenna array 310a, a new virtual antenna array with one single polarization can be generated, which potentially could increase the risk of polarization mismatching between the transmission and reception point 110 and the repeater node 200. In case the signal combiner 540 is a maximum ratio combiner the signal from the antenna elements 320a, 330a of both polarizations in the first antenna array 310a will be combined in an optimal way, which will remove the risk of polarization mismatch between the transmission and reception point 110 and the repeater node 200.

Regardless how much signal power is received at the antenna elements 320a, 330a of each of the first polarization and the second polarization, the maximum output power of the repeater node 200 can be achieved (assuming all power amplifiers have the same maximum output power), since the same signal strength will be allocated to each of the antenna elements 320b, 330b of the second antenna array 310b. This will not be the case for the example in FIG. 3, where, for example, in case a signal only is received in one polarization (i.e., either the first polarization or the second polarization), only half of the power amplifiers of the antenna system 300 will be used. This will reduce the maximum power amplification with 3 dB compared to this second embodiment.

Particular details of the third embodiment of the proposed antenna system will now be disclosed with continued reference to FIGS. 8, 9, and 10.

In accordance with the third embodiment, a signal received in one of the first polarization and the second polarization at the first antenna array 310a is split in two parts, where each of the two parts is fed to separate polarizations at the second antenna array 310b. In particular, in the dual-polarizing beamforming state the switching network 820 is set to selectively and one at a time either connect all the antenna elements 320a of the first polarization in the first antenna array 310a to all the antenna elements 320b, 330b in the second antenna array 310b or connect all the antenna elements 330a of the second polarization in the first antenna array 310a to all the antenna elements 320b, 330b in the second antenna array 310b.

In some variations of the third embodiment, the repeater node 200 further comprises an optional measurement module 260 placed in either the controller module 210 or the repeater module 240. The measurement module 260 is configured to measure received power per polarization in the first antenna array 310a. The antenna elements 320a, 330b of the polarization with strongest received power, as indicated by the measurement module 260, can then be connected to all the antenna elements 320b, 330b in the second antenna array 310b. Hence, whether the switching network 820 is set to connect all the antenna elements 320a of the first polarization in the first antenna array 310a to all the antenna elements 320b, 330b in the second antenna array 310b or to connect all the antenna elements 330a of the second polarization in the first antenna array 310a to all the antenna elements 320b, 330b in the second antenna array 310b might be determined as a function of the received power per polarization in the first antenna array 310a as measured by the measurement module 260. In this way the relative phase and amplitude between the first polarization and the second polarization will be known (and be the same). This will enable proper dual-polarized beamforming.

According to the third embodiment, the switching network 820 comprises switches 830 and at least one signal splitter 850. In FIGS. 8, 9, and 10, the switching network 820 comprises exactly five switches 830 and exactly one signal splitter 850.

For illustrative purposes the antenna arrays 310a, 310b have been illustrated to each comprise only four antenna elements of each polarization. However, it is noted that in practical implementations, each of the antenna arrays 310a, 310b might comprise hundreds of antenna elements.

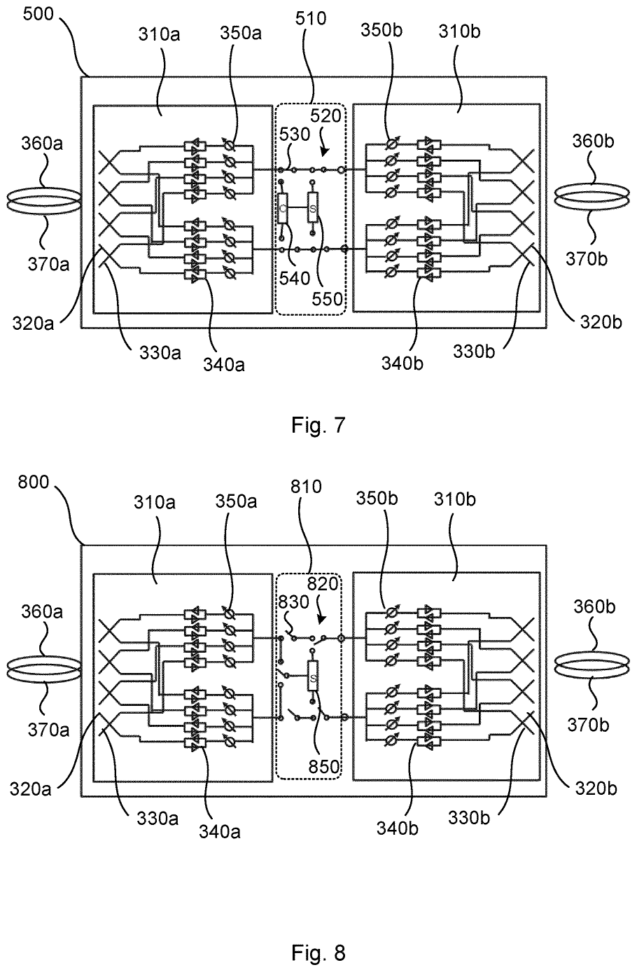

FIG. 11 is a flowchart illustrating embodiments of methods for using a repeater node 200 with an antenna system 400, 500, 800 as disclosed above for dual-polarized beamforming towards user equipment 120. The methods are performed by the controller module 210. The methods are advantageously provided as computer programs 1420.

S102: The controller module 210 controls the antenna system 400, 500, 800 to receive a signal in the first antenna array 310a from the transmission and reception point 110.

S104: The controller module 210 controls the antenna system 400, 500, 800 to forward the signal from the first antenna array 310a to the second antenna array 310b via the circuitry 410, 510, 810.

S106: The controller module 210 controls the antenna system 400, 500, 800 to transmit the signal from the second antenna array 310b towards the user equipment 120.

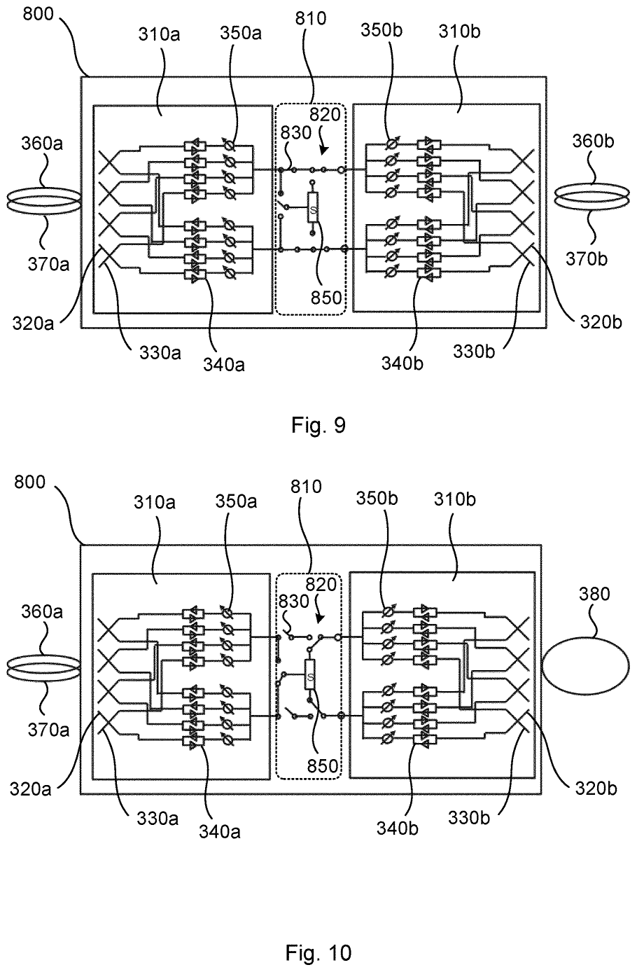

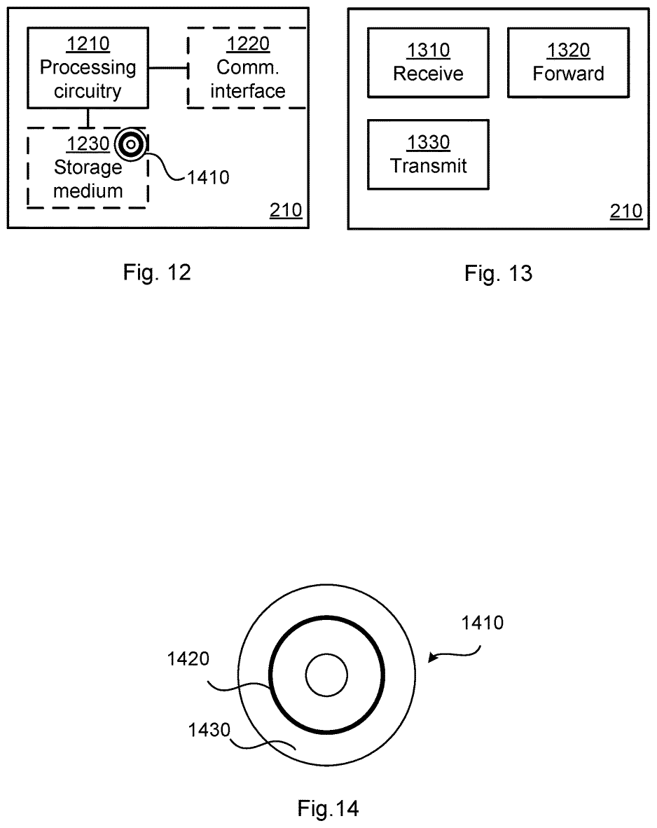

FIG. 12 schematically illustrates, in terms of a number of functional units, the components of the controller module 210 according to an embodiment. Processing circuitry 1210 is provided using any combination of one or more of a suitable central processing unit (CPU), multiprocessor, microcontroller module, digital signal processor (DSP), etc., capable of executing software instructions stored in a computer program product 1410 (as in FIG. 14), e.g. in the form of a storage medium 1230. The processing circuitry 1210 may further be provided as at least one application specific integrated circuit (ASIC), or field programmable gate array (FPGA).

Particularly, the processing circuitry 1210 is configured to cause the controller module 210 to perform a set of operations, or steps, as disclosed above. For example, the storage medium 1230 may store the set of operations, and the processing circuitry 1210 may be configured to retrieve the set of operations from the storage medium 1230 to cause the controller module 210 to perform the set of operations. The set of operations may be provided as a set of executable instructions.

Thus the processing circuitry 1210 is thereby arranged to execute methods as herein disclosed. The storage medium 1230 may also comprise persistent storage, which, for example, can be any single one or combination of magnetic memory, optical memory, solid state memory or even remotely mounted memory. The controller module 210 may further comprise a communications interface 1220 at least configured for communications with the network node 150. As such the communications interface 1220 may comprise one or more transmitters and receivers, comprising analogue and digital components. The controller module 210 further implements an interface to the repeater module 240.

The processing circuitry 1210 controls the general operation of the controller module 210 e.g. by sending data and control signals to the communications interface 1220 and the storage medium 1230, by receiving data and reports from the communications interface 1220, and by retrieving data and instructions from the storage medium 1230. Other components, as well as the related functionality, of the controller module 210 are omitted in order not to obscure the concepts presented herein.

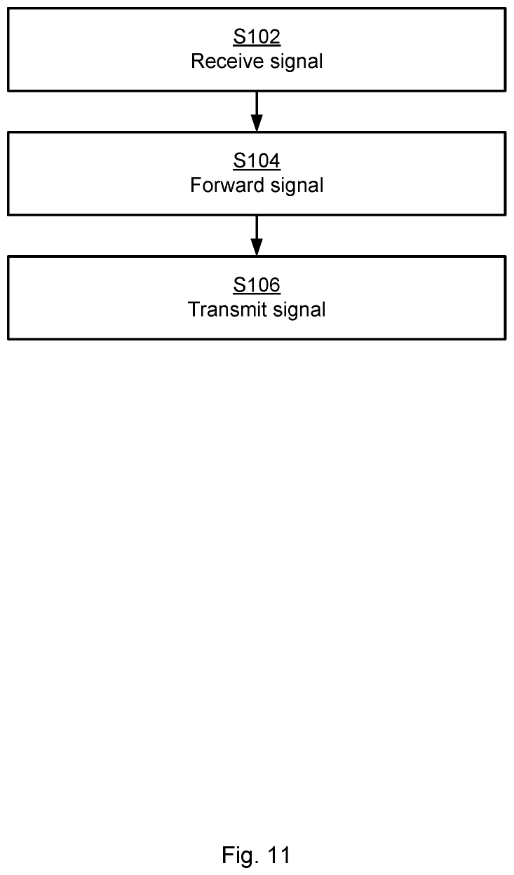

FIG. 13 schematically illustrates, in terms of a number of functional modules, the components of the controller module 210 according to an embodiment. The controller module 210 of FIG. 13 comprises a number of functional modules; a receive module 1310 configured to perform step S102, a forward module 1320 configured to perform step S104, and a transmit module 1330 configured to perform step S106. The controller module 210 of FIG. 13 may further comprise a number of optional functional modules. In general terms, each functional module 1310:1330 may in one embodiment be implemented only in hardware and in another embodiment with the help of software, i.e., the latter embodiment having computer program instructions stored on the storage medium 1230 which when run on the processing circuitry makes the controller module 210 perform the corresponding steps mentioned above in conjunction with FIG. 13. It should also be mentioned that even though the modules correspond to parts of a computer program, they do not need to be separate modules therein, but the way in which they are implemented in software is dependent on the programming language used. Preferably, one or more or all functional modules 1310:1330 may be implemented by the processing circuitry 1210, possibly in cooperation with the communications interface 1220 and/or the storage medium 1230. The processing circuitry 1210 may thus be configured to from the storage medium 1230 fetch instructions as provided by a functional module 1310:1330 and to execute these instructions, thereby performing any steps as disclosed herein.

The controller module 210 may be provided as a part of the repeater node 200, for example as illustrated in FIG. 2.

FIG. 14 shows one example of a computer program product 1410 comprising computer readable storage medium 1430. On this computer readable storage medium 1430, a computer program 1420 can be stored, which computer program 1420 can cause the processing circuitry 1210 and thereto operatively coupled entities and devices, such as the communications interface 1220 and the storage medium 1230, to execute methods according to embodiments described herein. The computer program 1420 and/or computer program product 1410 may thus provide means for performing any steps as herein disclosed.

In the example of FIG. 14, the computer program product 1410 is illustrated as an optical disc, such as a CD (compact disc) or a DVD (digital versatile disc) or a Blu-Ray disc. The computer program product 1410 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1420 is here schematically shown as a track on the depicted optical disk, the computer program 1420 can be stored in any way which is suitable for the computer program product 1410.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A repeater node for dual-polarized beamforming towards user equipment,
wherein the repeater node comprises a first antenna array for communication with a transmission and reception point of a network node, and a second antenna array for communication with the user equipment,
wherein the first antenna array comprises antenna elements of a first polarization and antenna elements of a second polarization, and the second antenna array comprises antenna elements of a third polarization and antenna elements of a fourth polarization,
wherein the antenna elements of the first antenna array are connectible to the antenna elements of the second antenna array via circuitry, and
wherein the antenna elements of each of the first polarization and the second polarization in the first antenna array are, via the circuitry connectable to antenna elements of both the third polarization and the fourth polarization in the second antenna array

2. The repeater node-according to claim 1,
wherein the second antenna array is split into a first subarray and a second subarray, and
wherein the dual-polarized beamforming towards the user equipment is performed per each of the subarrays.

3. The repeater node according to claim 1,
wherein the circuitry comprises wires connecting the first antenna array to the second antenna array, and wherein the wires connect the antenna elements in the first antenna array to a first subarray and a second subarray in the second antenna array.

4. The repeater node according to claim 1,
wherein the circuitry comprises a first wire connecting all the antenna elements of the first polarization in the first antenna array to a first half of all the antenna elements of the third polarization in the second antenna array and to a first half of all the antenna elements of the fourth polarization in the second antenna array, and
wherein the circuitry comprises a second wire connecting all the antenna elements of the second polarization in the first antenna array to a second half of all the antenna elements of the third polarization in the second antenna array and to a second half of all the antenna elements of the fourth polarization in the second antenna array.

5. The repeater node according to claim 2,
wherein the first half of all the antenna elements of the third polarization in the second antenna array and the first half of all the antenna elements of the fourth polarization in the second antenna array define the first subarray, and
wherein the second half of all the antenna elements of the third polarization in the second antenna array and the second half of all the antenna elements of the fourth polarization in the second antenna array-(310b) define the second subarray.

6. The repeater node according to claim 1,
wherein the circuitry comprises a switching network to selectively switch the repeater node between operating in a dual-polarizing beamforming state and operating in a unicast state.

7. The repeater node-according to claim 6,
wherein in the unicast state the switching network is set to connect the antenna elements of the first polarization in the first antenna array to antenna elements of the third polarization in the second antenna array, and to connect the antenna elements of the second polarization in the first antenna array to antenna elements of the fourth polarization in the second antenna array, and
wherein in the dual-polarizing beamforming state the switching network is set to connect the antenna elements of each of the first polarization and the second polarization in the first antenna array to antenna elements of both the third polarization and the fourth polarization in the second antenna array.

8. The repeater node according to claim 6,
wherein in the dual-polarizing beamforming state the switching network is set to selectively and one at a time either connect all the antenna elements of the first polarization in the first antenna array to all the antenna elements in the second antenna array connect all the antenna elements of the second polarization in the first antenna array to all the antenna elements in the second antenna array.

9. The repeater node according to claim 1,
wherein the repeater node further comprises a measurement module to measure received power per polarization in the first antenna array.

10. The repeater node according to claim 9,
wherein the repeater node further comprises a controller module configured to report the measured received power per polarization in the first antenna array to the network node.

11. The repeater node according to claim 8,
wherein whether the switching network is set to connect all the antenna elements of the first polarization in the first antenna array to all the antenna elements in the second antenna array or to connect all the antenna elements of the second polarization in the first antenna array to all the antenna elements in the second antenna array is a function of received power per polarization in the first antenna array as measured by the measurement module.

12. The repeater node according to claim 8,
wherein the switching network comprises switches and at least one signal splitter.

13. The repeater node according to claim 6,
wherein in the dual-polarizing beamforming state the switching network is set to at the same time connect all the antenna elements in the first antenna array to all the antenna elements in the second antenna array.

14. The repeater node according to claim 13,
wherein the switching network comprises switches, at least one signal combiner, and at least one signal splitter.

15. The repeater node according to claim 14,
wherein the at least one signal combiner is a maximum ratio combiner configured to combine signals received at the antenna elements of the first polarization in the first antenna array with signals received at the antenna elements of the second polarization in the first antenna array.

16. The repeater node according to claim 1,
wherein the first polarization is orthogonal to the second polarization, and wherein the third polarization is orthogonal to the fourth polarization.

17. A method for using a repeater node for dual-polarized beamforming towards user equipment,
wherein the repeater node comprises a first antenna array for communication with a transmission and reception point of a network node, and a second antenna array for communication with the user equipment.
wherein the first antenna array comprises antenna elements of a first polarization and antenna elements of a second polarization, and the second antenna array comprises antenna elements of a third polarization and antenna elements of a fourth polarization.
wherein the antenna elements of the first antenna array are connectible to the antenna elements of the second antenna array via circuitry, and
wherein the antenna elements of each of the first polarization and the second polarization in the first antenna array are, via the circuitry, connectable to antenna elements of both the third polarization and the fourth polarization in the second antenna array.
wherein the method comprises:
receiving a signal in the first antenna array from the transmission and reception point;
forwarding the signal from the first antenna array to the second antenna array via the circuitry; and
transmitting the signal from the second antenna array towards the user equipment.
